(19) United States
(12) Patent Application Publication
(10) Pub. No.: US 2020/0140078 A1
(43) Pub. Date: May 7, 2020

(54) COMPACT VERTICAL TAKE-OFF AND LANDING (VTOL) AIRCRAFT UNIT HAVING PROPELLER FOR GENERATING VERTICAL LIFT

(71) Applicant: Weimin LU, NOVI, MI (US)

(72) Inventor: Weimin LU, NOVI, MI (US)

(21) Appl. No.: 16/356,769

(22) Filed: Mar. 18, 2019

Related U.S. Application Data
(60) Provisional application No. 62/756,534, filed on Nov. 6, 2018.

(51) Int. Cl. B64C 29/00; B64C 37/02; B64C 27/20; B64C 25/06; B64C 25/34

(52) U.S. Cl. CPC B64C 29/0025; B64C 37/02; B64C 25/34; B64C 25/06; B64C 27/20

(57) ABSTRACT

A compact Vertical Take-Off And Landing (VTOL) aircraft unit includes a duct fan including a propeller having a rotational axis which extends substantially vertically and discharges air downward to generate thrust sufficient for VTOL, an electric motor disposed above the duct fan and including an output shaft operatively connected to the propeller for rotating the propeller, and a cover disposed above the motor which is configured to support a load thereon. A gap is defined between the cover and the duct fan around an outer circumferential periphery of the aircraft and forms an opening of a primary flowpath for ambient air to the propeller, the primary flowpath for ambient air being non-parallel to the propeller's rotational axis.

### CROSS REFERENCE TO RELATED APPLICATIONS

The present application claims priority from U.S. Provisional Patent Application 62/756,534, filed Nov. 6, 2018. The entire disclosure of this prior application is incorporated herein by reference.

### BACKGROUND OF THE INVENTION

### Field of the Invention

The present invention relates to a Vertical Take-Off And Landing (VTOL) aircraft unit which may be used for transporting load such as passenger(s) and/or cargo, includes propeller(s) for generating thrust in a vertical direction, and is very compact. More particularly, the present invention relates to such a VTOL aircraft which includes a primary, VTOL thrust-generating, fixed propeller or duct fan (hereinafter propeller) which is disposed substantially at a bottom of the unit and has an outer diameter which is substantially the same as an outer circumference of the aircraft unit, a motor for driving the duct fan which is disposed above and coaxially connected to the duct fan, an upper cover which surrounds at least an upper portion of the motor and upon which an occupant and/or cargo may be situated, and a circumferential air intake defined between the duct fan and the upper cover which defines a primary flowpath for ambient air from outside of the aircraft to the propeller which is not parallel to the propeller's rotational axis. The air intake may have an outer diameter which is also substantially the same as the outer circumference of the aircraft unit.

### Description of the Background Art

There are many known types of VTOL aircrafts, many of which include fixed propeller(s) which rotate about vertical axes for generating the significant thrust needed to vertically lift the aircrafts off the ground and maintain the aircrafts in the air, e.g., helicopters and drones. Essentially all of the known VTOL aircraft with such fixed propeller(s) dispose the propeller(s) at upper and/or unobstructed positions of the aircraft so that the propeller(s) may intake essentially all of the ambient they require for generating the vertical thrust directly from above the propeller(s) along a vertical path parallel to the rotational axis of the propeller(s) and then discharge the air straight down at high velocity for generating the significant thrust need for vertical lift. Motor(s) for driving the propeller(s) are corresponding disposed below the propeller(s), and are typically connected to the propeller(s) along a common axis.

Although a propeller directly exerting downward force is the most efficient way to generate thrust for lift, as in the conventional VTOL aircraft, the upper, unobstructed positioning of the propeller(s) places limits the circumferential diameter of the motor(s) to be used to drive the propeller(s), again, because the motor(s) are typically disposed directly below and connected to the propeller(s) along a common axis, such that the motor(s) block and/or obstruct at least some portion of the high velocity airflow being discharged by the propeller(s), with the understanding that the larger the diameter of the motor the greater the portion of the high velocity airflow which is blocked and/or obstructed by the motor. Correspondingly, the typical disposition of the propeller(s) and their associated motor(s) greatly limits or prevents the ability to employ a large diameter and powerful motor for generating higher lift in a VTOL aircraft while also maintaining the size of the VTOL aircraft to be very compact.

A propeller may generate thrust or a lift force which is largely based on the propeller's size-outer diameter and on the strength/power of the motor which drives the propeller to rotate. With the conventional compact VTOL aircraft having propeller(s) with upper, unobstructed positions and associated motor(s) which are disposed below the propeller(s), the common arrangement used to generate higher lift from a propeller with a given outer diameter is to use motors which are smaller in outer diameter, but longer in axial length. Correspondingly, the motors in the conventional compact VTOL aircraft are typically much smaller in outer diameter than the outer diameter of the associated propeller. Unfortunately, the smaller diameter motors produce less torque than larger diameter motors, and the motors with axial lengths which are longer than the circumferential diameters of the motors have lower efficiency. The same can be said for the sizes of internal combustion (IC) engines that are often used to drive the propellers of compact VTOL aircraft rather than electric motors.

For a compact VTOL aircraft to have as small of ground footprint-size as possible, it is important that all components of the aircraft be disposed within a space having dimensions not exceeding the diameter of the propeller. There are many types of VTOL aircrafts. However there are very few constructions in which their physical sizes are limited to be within the diameter of the propeller.

For example, U.S. Pat. No. 2,953,321 by Arthur Robertson discloses a VTOL aircraft primarily including two relatively large propellers disposed within a cylindrical, framed enclosure and which rotate in opposite directions, and a relatively small and open platform disposed above the propellers on which a person/operator stands while having his/her feet securely strapped into braces, such that a primary flow of air to the propellers is along a path which is substantially parallel to the axes of the propellers. Although the operator is positioned directly above the propellers, he/she does not significantly block ambient air above the propellers from being sucked straight vertically down to the large propellers because the size-diameter of the operator is much smaller than that of the propellers. This VTOL aircraft does not provide any significantly sized space/area for accommodating passengers and/or cargo. Similar other designs include a tubular or barrel shaped member disposed above a propeller or counter rotating propellers, and an operator of the aircraft stands inside the tubular or barrel shaped member. Again, a person or barrel shaped member has a much smaller diameter than that of the vehicles propeller(s), and does not significantly block ambient air above the propellers from being sucked straight vertically down to the large propeller(s).

U.S. Pat. No. 6,976,653B2 by Piero Perlo discloses an aircraft that uses 2 propellers on a common axis, one above the other, for VTOL. The top propeller intakes ambient air directly above it along a path parallel to its axis and the bottom propeller intakes air from directly above it, including air discharged by the top propeller, along a path parallel to its axis. This VTOL aircraft cannot have a large cover disposed above the top propeller that blocks-obstructs because the propeller design relies on ambient air being sucked in to the propellers from directly above in unobstructed manner. Also, U.S. Pat. No. 6,854,686B2 by Piero Perlo discloses another personal aircraft that uses 2 propellers on a same axis for VTOL, with a compact, single-person capsule disposed between the two propellers. Again, the top propeller intakes ambient air primarily from directly above it and the bottom propeller intakes air primarily from directly above it, including high velocity air discharged by the top propeller. The propellers do not intake ambient air primarily from circumferential sides (or 360° around) the propellers, which is possible because the passenger capsule is much smaller in diameter than the propellers so that the lower propeller intakes ambient air still directly from above including air passing around the capsule. Again, these VTOL aircraft do not provide any significantly sized space/area for accommodating passengers and/or cargo, and cannot have a large cover disposed above the top propeller, such as a canopy, because the propeller design relies on ambient air being sucked into the propellers from directly above.

U.S. Pat. No. 6,883,748B2 by Rafi Yoeli discloses an aircraft that uses two propellers which rotate about a longitudinal axis for VTOL. Both propellers intakes ambient air directly from above and correspondingly cannot have any large cover which blocks-obstructs airflow from above the propellers because the propellers are required to suck in ambient air from directly above.

U.S. Pat. No. 6,745,977B1 by Larry Long discloses a flying automobile that uses 2 main propellers which are longitudinally spaced from each other and rotate about separate vertical axes for VTOL. The space above the propellers is left wide open and unobstructed so that the propellers can intake ambient air directly above them. This VTOL aircraft is not compact.

U.S. Pat. No. 4,941,628 by Yujiro Sakamoto discloses an aircraft that uses high-pressure gas producing device, such as a turbofan for VTOL. The turbofan sucks ambient air from the lateral sides of the aircraft, the sucked air passes through a channel with multiple turns to the fan blades and with the motor disposed below the blades, not through an open gap between the fan and motor, while high velocity airflow discharged by the turbofan is also redirected 90° downwards by a bowl shaped wing resulting in the downwards airflow having velocity loss. The arrangement of the motor with fan blades together, again, limits the size of the motor. Also, the size of the aircraft is significantly larger than the outer diameter of the fan blades.

U.S. Pat. No. 3,901,463 by Andre Kovacs discloses a larger aircraft that uses two horizontal-axial propellers for VTOL. The propellers intake ambient air only from two sides of the aircraft horizontally, not all sides, or 360° around, and then discharge the air at high velocity while redirecting the discharged airflow 90° downward. Such redirection of the discharged air causes the downwards airflow to have velocity loss.

Some U.S. Pat. No. 8,579,227B2 by J. Kellogg Burnham discloses an aircraft that uses blowers and airfoils for VTOL-lift. It does not directly exert air downwards for lift, and is not otherwise compact.

Thus, while there are many known types of VTOL aircraft, including some with propeller(s) for generating thrust for VTOL and some which are compact, a need still exists in the art for a VTOL aircraft unit which may be used for transporting passenger(s) and/or cargo, includes propeller(s) for generating thrust in a vertical direction, is very compact and very powerful, and may be manufactured efficiently and economically.

### SUMMARY OF THE INVENTION

It is an object of the present invention to provide an VTOL aircraft which satisfies the discussed need.

According to a first aspect of the present invention there is provided a compact Vertical Take-Off And Landing (VTOL) aircraft unit which comprises: a duct fan including a propeller having a rotational axis which extends substantially vertically and discharges air downward to generate sufficient thrust for VTOL; an electric motor disposed above the duct fan and including an output shaft operatively connected to the propeller for rotating the propeller; and a cover disposed above the motor which is configured to support a significant load thereon, wherein a gap is defined between the cover and the duct fan around an outer circumferential periphery of the aircraft which forms an opening of a primary flowpath of ambient air to the propeller, the primary flowpath of ambient air being non-parallel to the propeller's rotational axis. Additionally, the fan duct may be disposed substantially at a bottom portion of the aircraft unit, an outer circumferential diameter of the duct fan is at least as large as an outer circumferential diameter of any other component of the aircraft unit, and none of the other components of the aircraft unit substantially obstruct the high velocity air which is discharged by the fan.

The VTOL aircraft unit according to the first aspect of the present invention is very advantageous over conventional compact VTOL aircraft units for multiple reasons. For example, by arranging the motor which rotates the duct fan propeller above the propeller, as well as providing the cover disposed above the motor and providing the gap defined between the cover and the duct fan around the outer circumferential periphery of the aircraft unit as the opening of a primary flowpath of ambient air to the propeller which is non-parallel to the rotational axis of the propeller, this permits the motor to have a large circumferential diameter, e.g., as large as that of the duct fan, which can more efficiently generate greater output and greater torque than a similarly sized motor having a relatively small outer circumferential diameter and a longer axial length. Essentially, limitations on size and shape of the motor in conventional VTOL aircraft having the motor disposed above the propeller are eliminated by the present invention. Further, by disposing the fan substantially at a bottom portion of the aircraft unit and such that no other component of the aircraft unit substantially obstructs the air which is discharged downward by the propeller, there is no loss on the output of the fan, which permits the aircraft unit to generate greater lift force for a given diameter of the propeller being driven by a given size motor. Conversely, there is significant reduction of the output of the fan caused by redirecting the high velocity air as discharged from a propeller, as is done in some of the known VTOL aircraft. Also, by providing the gap defined between the cover and the duct fan as the opening of a primary flowpath of ambient air to the propeller which is non-parallel to the rotational axis of the propeller ambient air to the propeller from around an outer circumferential periphery (radial 360°) of the aircraft, rather than along a straight path vertically above the propeller, there is no restriction on the ability of the propeller to draw in, and subsequently discharge, an unlimited quantity of ambient air at any rotation speed of the propeller which can be achieved by the larger diameter motor. The result is more lift force at given diameter of a propeller. Still further, because the fan-propeller has an outer circumferential diameter which is at least as large as an outer circumferential diameter of any other component of the aircraft unit, all components of the aircraft are disposed within the outer circumference or footprint of the fan-propeller, and will not generate any undue drag or resistance that would inhibit VTOL movements of the aircraft. Collectively, these advantages lead to a very compact VTOL aircraft.

According to a second aspect of the present invention, in addition to the first aspect, an outer diameter of the motor may be greater than an axial length of the motor, and outer diameter of the motor is preferably at least 50% as large as the outer diameter of the duct fan, and most preferably is substantially as large as that of the duct fan such that a rotor of the motor also functions as a flywheel.

The VTOL aircraft unit according to the second aspect of the present invention is very advantageous because by providing the motor in a sufficiently large size that the motor's rotor also functions as a flywheel of the aircraft to intrinsically and automatically balance and stabilize the aircraft while airborne, whereby the airborne aircraft may be maintained in a horizontal, stable position so that the propeller forcibly discharges air directly downwards at all times. Without such stability provided by the rotor-flywheel, the lift generated by the propeller at the bottom of the aircraft combined with the aircraft having a relatively high center of gravity due to the motor's position above the propeller would tend to create some instability for the aircraft, and any such instability would have to be counteracted in some other way, such as by adding other device(s) dedicated to such purpose.

According to a third aspect of the present invention, in addition to the first or second aspect, the cover may have a circumferential diameter which is substantially the same as the outer diameter of the duct fan, and the cover may be shaped like a canopy concave facing toward the motor. Further, the circumferential diameter of the motor may be slightly less than the circumferential diameter of the cover, while the axial length of the motor may be substantially the same as a vertical height of the cover, such that the cover covers the upper surface of the motor and surrounds the outer circumferential periphery of the motor.

The VTOL aircraft unit according to the third aspect of the present invention is additionally advantageous because by providing cover to have an outer circumferential diameter which is substantially the same as the outer diameter of the fan-propeller, this permits the cover to have a relatively large area for supporting an occupant, cargo, controls and other components of the aircraft, while maintaining the size of the aircraft itself to be relatively small-compact because it is still within the footprint of the fan. Further, the cover provides protection for the motor and because the cover is directly above the primary path of ambient air to the propeller as taken in through the gap, this creates a vortex of air movement inside the cover which desirably functions to cool down the motor. Still further, the canopy-shaped cover may function as a type of small, deployed parachute to slowdown descending movement of the aircraft in case of motor failure.

According to a fourth aspect of the present invention, in addition to any of the first, second and third aspects, for purposes of for horizontal maneuvering the VTOL aircraft may further include one or more directional fans supported on the upper surface of the cover and/or a plurality of shutters (fins) disposed in or near the gap around the outer circumferential periphery of the aircraft and which may be selectively rotated individually or in groups to close any portion of the gap.

The VTOL aircraft unit according to the fourth aspect of the present invention is additionally advantageous because the directional fan(s) may be relatively small and provided at a location which does not create any significant drag for the aircraft, such as on top of the cover, while the plurality of shutters as provided in or near the gap do not increase the size of the aircraft, can be controlled to essentially steer or guide horizontal movements of the aircraft, and will provide some protection against foreign objects passing through the gap to the propeller.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

FIG. 1 is a top perspective view of a compact VTOL aircraft unit according to a first illustrative embodiment of the present invention.

FIG. 2 is a side sectional view of the compact VTOL aircraft unit of FIG. 1 taken in the direction of line A-A.

FIG. 3 is a side sectional view of a compact VTOL aircraft unit according to another illustrative embodiment of the present invention which similar to FIG. 2, but includes a motor with a smaller circumferential diameter and a longer axial length than the motor in FIG. 2.

FIG. 4 is a side sectional view of a compact VTOL aircraft unit according to another illustrative embodiment of the present invention which similar to FIG. 2, but wherein an upper portion of a casing of the motor also functions as an upper cover of the aircraft.

FIG. 5 is a side sectional view of a compact VTOL aircraft according to another illustrative embodiment of the present invention, wherein multiple compact VTOL aircraft units such as in FIG. 1 are joined together and a space for passenger(s), cargo and the like is defined between the units.

### DETAILED DESCRIPTION OF THE PRESENT ILLUSTRATIVE EMBODIMENTS

A number of selected illustrative embodiments of the invention will now be described in some detail, with reference to the drawings. It should be understood that only structures considered necessary for clarifying the present invention are described herein. Other conventional structures, and those of ancillary and auxiliary components of the system, are known and understood by those skilled in the art. These illustrative embodiments are compact VTOL aircraft units and various components of same.

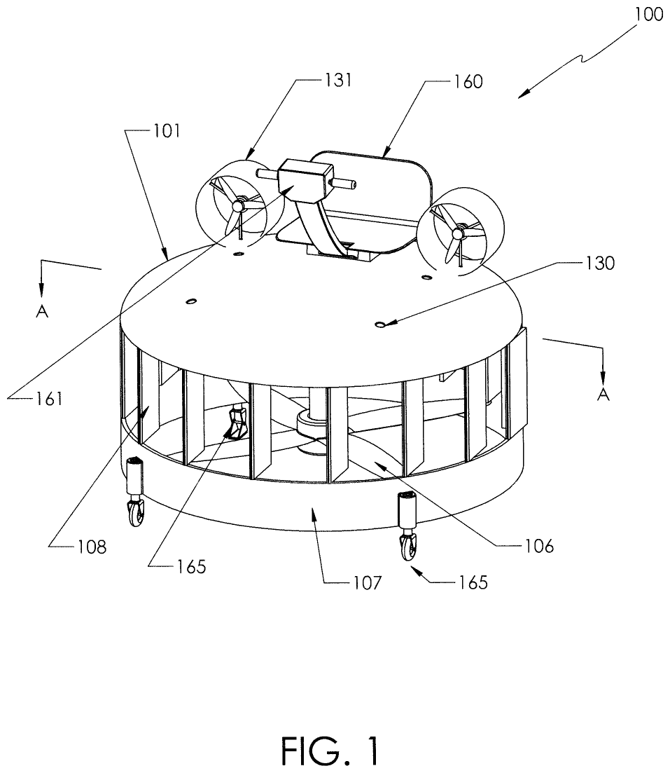

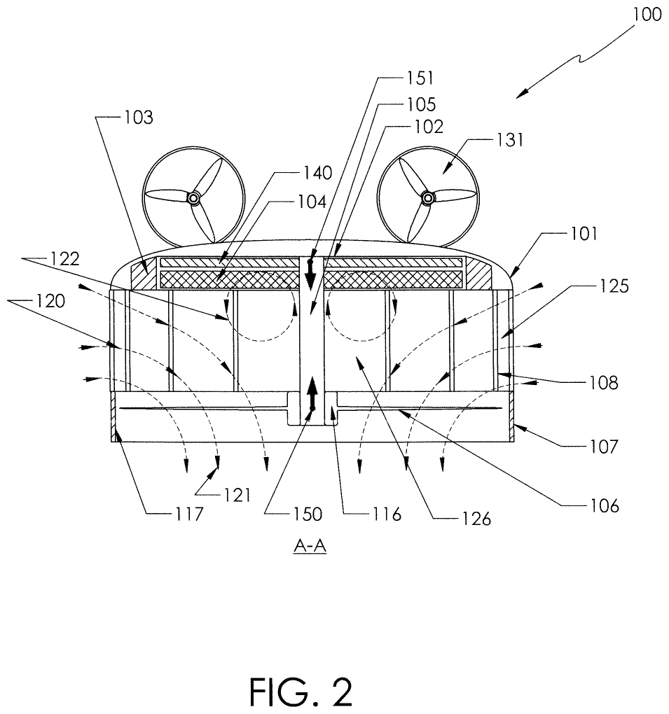

Referring now to the FIGS. 1 and 2, there is shown a compact VTOL aircraft according to a first illustrative embodiment of the present invention, generally denoted by reference numeral 100 and having shape somewhat resembling that of a hamburger. The VTOL aircraft 100 generally includes an upper cover or canopy 101, a motor 102 disposed immediately below the cover, and a duct fan 107 on a common vertical axis with the motor. The fan 107 which generates a primary thrust necessary for vertical take-off and lift of the aircraft is disposed at a bottom portion of the VTOL aircraft spaced away from the motor 102 and arranged directly below the motor with a large open space there between.

A large open gap 125 is defined at an outer circumferential-radial periphery of the opening vertically between the canopy 101 and the fan 107 whereby a primary flowpath for ambient air to the fan 107 is established through the gap 125 and a large open space 126 between the motor 102 and the duct fan 107, and the primary flowpath is sufficiently large that there is no restriction on the ability of the fan to draw in as much ambient air as the fan is capable of moving based on its size and the characteristics of the motor 102 which drives the fan. For example, if the outer circumferential diameter of the canopy 101 is the same size as that of the propeller 106, the minimum gap distance of the open gap 125 should be at least a quarter diameter of the propeller 106, assuming that a negligible amount of ambient air is being drawn from above the cover 101, through the cover and the motor 102 to the propeller along a path that is substantially parallel to the motor output shaft 105. The path of ambient airflow through the open gap 125 and the open space 126 involves initial intake of ambient air 120 from the radial circumferential side of the aircraft unit 100, 360° radially inwards through the open gap in a direction which is not parallel to the rotational axis of the fan, then once the airflow is in the open space 126 the airflow is sucked down into the propeller 106 of the fan, such as indicated by the broken lines in FIG. 2. Therefore the primary intake path of ambient air is not straight down from above the aircraft and not substantially parallel to the rotational axis of the fan, as it is in many of the conventional VTOL aircraft.

Because the primary airflow path is turned or redirected before it enters the duct fan 107, rather than after it is discharged by the fan there is no output loss from the fan 107. Further, the conventional limitations on a motor circumferential diameter in the conventional VTOL aircraft units is eliminated in the present invention because it does not matter if the motor diameter is so large that it substantially completely blocks airflow from above the aircraft unit straight down into the fan. The large open gap 125 and the large open space 126 ensure that the volume of the ambient air 120 available to be in-taken by the propeller 106 via the primary flowpath is not less than would occur if there was an unrestricted flowpath to the duct fan which is substantially parallel to the rotational axis of the fan. In another words, provisional of the canopy 101 and the motor 102 having a large outer circumferential diameter in the depicted embodiment of the present invention does not impose any restriction on the ability of the fan propeller to draw in as much air as it can handle, while the discharge of high velocity air straight downward without redirection or obstruction assures that the output power of the duct fan 107 is not reduced from its potential maximum. Because of the propeller 106 faces directly downward without obstruction, its exerting airflow 121, or thrust directly generates lift force by Newton's 3^{rd} law, and there is no velocity loss.

By forming the primary flowpath for ambient air via the large gap 125 and large open space 126, this eliminates any size restriction on the outer circumferential diameter of the motor 102 and permits essentially the entire upper surface of the canopy 101 to be advantageously used for supporting occupant(s) of the aircraft, cargo, and other components of the aircraft unit 100, e.g., a passenger seat 160 and a computer controller 161 are depicted in FIG. 1 are merely examples of some of the items which can be supported on the cover, because the aircraft unit does not rely on airflow passing through the cover 101 to the duct fan 107. It is not required that the cover-canopy 101 completely block all ambient airflow through the cover, and if the cover has openings defined therethrough such as the small vent openings 130 as depicted, some ambient air will pass from above the cover in the direction of the fan. However, because the primary flowpath for ambient air to the fan is through the large gap 125 and large open space 126, the aircraft unit 100 does not require or rely on any flow of ambient air from above the cover, through the cover to the fan. Incidentally, provision of vent openings 130 is desirable for permitting the canopy shaped cover to function as a small, deployed parachute for the aircraft unit 100 in the unlikely event of a failure that prevents the duct fan from operating properly.

A plurality of directional fans 131 may be disposed on the canopy 101 or elsewhere on the aircraft. The directional fans 131 are much smaller than the primary duct fan 107, rotate about axes which extend generally horizontal, and primarily function to control horizontal maneuvering of the aircraft. Additionally a plurality of shutters or fins 108 may be disposed in or near the gap 125 around the outer circumferential periphery of the aircraft and which may be selectively manipulated, individually or in groups, to close or restrict any portion of the gap as another means of controlling horizontal maneuvering of the aircraft. For example, by limiting-restricting where the ambient air around the aircraft may be drawn in through the gap 125, this will cause a sufficient amount of the ambient air to be drawn to the fan-propeller through the non-restricted portion(s) of the gap, and will also the aircraft to move in a direction away from the restriction. The shutters 108 are also useful for blocking foreign objects from entering the open space 126, and hence from being drawn into the fan.

While it will be understood that the compact VTOL aircraft 100 would include other basic components necessary for an aircraft, e.g., means to secure occupant(s) and/or cargo to the aircraft, means to protect occupant(s) and/or cargo as disposed on the aircraft, instrumentation, controls for maneuvering the aircraft, batteries, fuel cell, and/or other power source for driving powered components of the aircraft including the motor 102 and the duct fan 107, the shutters 108, and other components of the aircraft, some type of landing gear 165, etc., these other basic components are omitted in all drawings for ease of understanding. Many of these other components may be supported by the upper surface of the canopy 101.

The duct fan 107 may include a propeller 106 having multiple blades and a central hub 116 fixed to the free end of a rotatable output shaft 105 of the motor 102 and a vertically extending, circular wall or casing 117 which radially surrounds an outer circumferential periphery of the propeller. The duct fan 107 discharges air 121 at high velocity directly downward to produce the significant vertical thrust necessary for vertical takeoff and lift of the aircraft, and is sufficiently sized to achieve this purpose. The tips of the propeller blades may extend outwardly close to the casing 117, and the casing 117 protects the propeller from coming into contact which foreign objects, occupants, etc. While the duct fan 107 is depicted as having only one propeller 106 with multiple blades that are all disposed in a single plane and rotate together, other possible structures of the duct fan 107 may be adopted. For example, the fan may include two or more propellers 106 disposed coaxially one above the other. Also, different ones of the propellers may rotate in opposite directions while still discharging high velocity air downward, which would provide an additional benefit of added stability for the aircraft as yaw moment created in one direction by one of the propellers can be offset by yaw moment created in the opposite direction by another of the propellers.

The motor 102 may be an electric motor driven by an appropriate power source (not shown) such as batteries, a fuel cell, etc., and the motor 102 may generally include a stator 103 and a rotor 104 with the rotatable output shaft 105 connected to the propeller 106 by the central hub 116. In this embodiment the motor 102 is a so-called pancake or pancake-shaped motor because it has an outer circumferential diameter which is significantly larger, e.g., at least twice, than its axial length. As depicted, the outer circumferential diameter of the motor 102 is approximately ten times as large as its axial length, and its upper and side surfaces are completely surrounded by the canopy 101. The outer circumferential diameter of the pancake motor 102 may be as large as the outer circumferential diameter of the canopy 101. While use of such a pancake motor 102 greatly limits the ability of the duct fan 107 to draw in ambient air from directly above the motor straight down in a path parallel to the motor output shaft 105 because the motor 102 will block much of the ambient air above the motor from flowing directly to the duct fan 107, this is no problem for the aircraft unit 100. Again, the primary flowpath for ambient air to the fan-propeller is defined by the gap 125 and the large open space 126, and this primary flowpath can provide all of the ambient airflow required by the fan as discussed above. Using a pancake motor for the compact VTOL aircraft unit 100 is otherwise very advantageous for the aircraft unit 100. For example, because of its large diameter the pancake motor 102 can generate higher torque and higher output than another motor which has similar mass but which has a much smaller outer circumferential diameter and a much longer axial length. Higher torque and output are highly desirable for the propeller 106 to efficiently generate greater lift force.

Because of the pancake shape of the motor 102, the rotor 104 also has a large diameter, which provides an additional advantage, i.e., as the large diameter rotor 104 rotates, it also functions as a flywheel that may intrinsically and automatically balance and stabilize the VTOL aircraft 100 while airborne. Therefore, vertical moving up or down of the aircraft 100 is controlled by the lift force generated by the fan propeller 106 and is stabilized by the spinning rotor 104, the flywheel. This is an important and advantageous aspect of the present invention.

Due to the arrangement of the duct fan 107 at the bottom portion of the aircraft unit and a relatively high center of gravity of the aircraft unit based on disposition of heavier components including the motor 102, cover 101 and/or any load disposed on the cover at the upper portion of the aircraft unit 100, this creates two significant forces on a common axis of the aircraft unit 100, i.e., the lift generated by the propeller creates a lift force 150 directed upward and the relatively high center of gravity of the aircraft unit creates a gravity force 151 directed downward. Together, these two forces facing each other with the gravity force 151 higher than the lift force 150 would tend to inherently create some instability for the aircraft while airborne, and should be counteracted to assure stability for the aircraft unit when airborne. An analogy to such inherent instability of the aircraft unit 100 is a top having a large upper portion and a point at its central bottom portion. When the top is not spinning, no lift force directed upward is generated at the central bottom portion of the top, while based on the top's high center of gravity a gravity force directed downward along a common axis above the lift force, and the resulting instability causes the top to fall over. However, when the top is spinning, by conservation of angular momentum the spinning top is more stable against torques produced by the gravity force. In the exemplary embodiment of the present invention, the large diameter rotor 104 advantageously provides such counteracting stability, and does so simply based on the large outer circumferential diameter of the motor 102 whereby the rotor 104 also has a correspondingly large outer circumferential diameter which permits to rotor to also function as a flywheel and provide stability for the aircraft unit. Particularly, the rotor-flywheel 104 intrinsically and automatically balances and stabilizes the aircraft unit 100 while airborne, whereby the airborne aircraft unit may be reliably maintained in a horizontal, stable position so that the propeller forcibly discharges air directly downwards at all times. If not for the ability of the rotor 104 to function as a flywheel, the instability created by the arrangement of the components of the aircraft unit would have to be counteracted in some other way, such as by adding other device(s) dedicated to such purpose.

Incidentally, conventional VTOL aircraft having the main propeller disposed at the upper portion of the aircraft for generating thrust required for VTOL and having a relatively low center of gravity closer to the bottom portion of the aircraft based on disposition of heavier components including the motor closer to the bottom portion of the aircraft may not have an inherent instability unlike the aircraft unit 100 according to the present invention. In such conventional VTOL aircraft the propeller creates a force directed upward at the upper portion of the aircraft, while the relatively low center of gravity of the aircraft unit creates a gravity force directed downward at the lower portion of the aircraft such that the two forces would tend counteract each other such that they would not create instability for the aircraft.

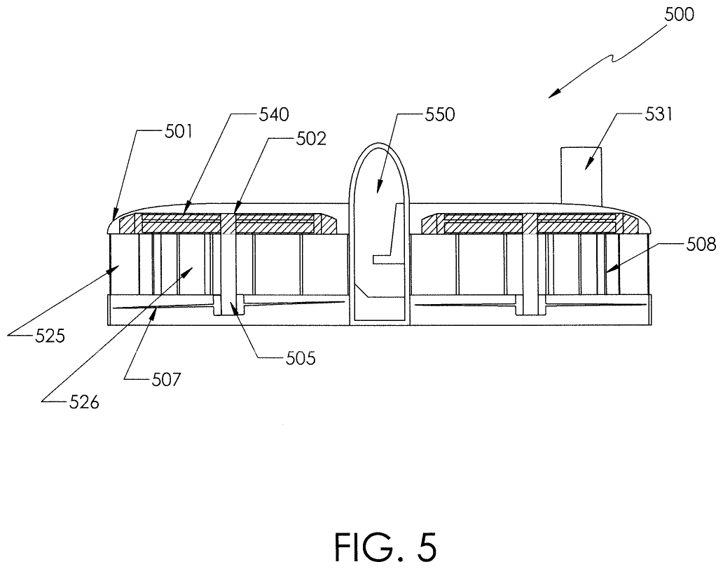

As depicted, an optional counter flywheel 140 may be provided and disposed with the motor 102, and the counter flywheel would rotate in an opposite direction to the direction in which the rotor 104 rotates. When a single aircraft 100 unit such as depicted in FIGS. 1-2 is flown, it would have a tendency to self-turn when the rotor 104 and propeller 106 rotate because these spinning components generate some yaw moment for the aircraft. Provision of the counter flywheel 140 would be desirable because it spins counter rotation to the rotor 104, and thereby generate some yaw moment in an opposite direction to that generated by the other components which may offset any net yaw moment generated by the rotating rotor 104 and propeller 106 and thereby keep the aircraft 100 from self-turning while airborne. Although directional fans 131 may be controlled to prevent the self-turning of the aircraft 100, it is desirable for the directional fans 131 to have only one function of horizontally maneuvering the airborne aircraft and not be relied on for the additional function of preventing self-turning of the aircraft 100. If a aircraft combines a plurality of the aircraft units 100 such as in the exemplary embodiment of FIG. 5 herein, the counter flywheel 140 may not be needed as the tendency toward self-turning of one of the aircraft units 100 can be offset by the tendency toward self-turning of another of the aircraft units 100. Similarly, if the duct fan 107 includes a plurality of propellers which rotate in opposite directions as discussed above, again the counter flywheel 140 may not be needed.

According to an important aspect of the present invention the outer circumferential dimension of the duct fan 107 essentially establishes the overall compact size of the aircraft unit 100 as all other components of the aircraft unit are constructed to fit within the outer circumferential footprint of the duct fan, including components which are not shown in the drawings. With such construction the aircraft unit 100 is not only very compact, but also more aerodynamic compared to an aircraft structure in which other components projected outside of the outer circumferential footprint of the duct fan.

According to another important aspect of the present invention the duct fan 107 and the motor 102 which drives the fan are permitted to have a smallest possible size and mass sufficient to reliably achieve the significant vertical thrust necessary for vertical takeoff and lift of the aircraft. There are multiple reasons for this. For example, there is essentially no limitation on the outer circumferential size of the motor 102 except that it not exceed that of the fan, again, because the primary flowpath for ambient air to the fan-propeller 106 is through the large gap 125 and the large open space 126. While the motor 102 may be a pancake motor having an outer circumferential diameter which is relatively large, the axial length of the motor is relatively small, and the overall size and mass of the motor can be reduced based on its efficiency in generating higher torque and higher output than other motors which having similar mass as discussed above. Therefore the diameter of the duct fan 107 may be made smaller with the more powerful pancake motor 102 to achieve even smaller ground footprint of the aircraft 100. Another reason is that the air is discharged at high velocity by the fan straight downward without diversion while the aircraft does not include any obstructions in the path of the high velocity air that is discharged by the fan so that the fan output is given its maximum effect.

The cover-canopy 101 is disposed to cover upper and side surfaces of the motor 102 and the upper surface of the canopy, may be formed of any appropriate, rigid material such as metals and/or plastics. Again, the cover 101 may have a solid, continuous upper surface or may have openings such as the small vent openings 130 defined therein which permit ambient air to pass through the cover to the duct fan 107. Of course, even if openings are defined through the canopy to permit some airflow therethrough, the motor 102 having a large outer circumferential diameter will block much of such airflow from passing directly to the fan, but this is not a problem because the primary airflow path to the fan is via the large gap 125 and the large open space 126 as discussed above. Any airflow passing through the openings in the canopy 101 will also help cool the motor 102. As depicted, the cover may have a shallow, concave or dome shape like a canopy, while the outer circumferential diameter of the cover 101 may be as large as that of the duct fan 107, and would still desirably fit within the outer circumferential footprint of the duct fan. The cover 101 may be a separate component from the motor 102 as in the embodiment of FIGS. 1-2, but it is also possible for the cover to be an upper part of a housing or casing of the motor 102, such as in the embodiment of the invention shown in FIG. 5.

Again, because the aircraft unit 100 does not rely on ambient air flowing through the canopy 101 to the duct fan 107, this permits essentially the entire upper surface of the canopy 101 to be advantageously used for supporting a large load, including occupant(s) of the aircraft, cargo, and other components of the aircraft unit 100 (which are not depicted in the drawings). Further, depending on the relative sizes of the canopy and the motor 102, some space for disposing other components of the aircraft such as batteries (not shown) and control devices (not shown) may be defined between the canopy and the motor. For example, as shown in FIG. 2 there is some space defined radially outside the stator 103 of the motor and the canopy where other components of the aircraft may be located.

Given that the shape of the cover-canopy 101 may be like a shallow dome cap with some small vent openings 130, this also permits the canopy to effectively act as a built-in small deployed parachute to slowdown descending motion of the aircraft unit 100 in case of motor failure or the like. Of course, other safety features and precautions should also be provided in case of malfunctions such as motor failure. Also, due to presence of the canopy 101 and the large open space between the motor and the fan, when the ambient air 120 flows to the fan via the primary flowpath, a vortex 122 will be generated near the bottom of the motor 102 that may function as cooling air to cool the motor 102.

Again, a plurality of movable shutters or fins 108 may be disposed in or near the gap 125 around the periphery of the aircraft and which may be selectively manipulated, individually or in groups, to close or restrict any portion of the gap as another means of controlling horizontal maneuvering of the aircraft. For example, the shutters 108 may be selectively controlled in at least 4 groups, generally corresponding to the four directions E, W, N, S, as control surfaces for horizontal maneuvering of the aircraft unit. For example, when a group of shutters on an east side of the aircraft unit 100 is closed or partially closed, the intake airflow from west will correspondingly be much stronger, and by Newton's 3^{rd} law the aircraft 101 must move towards west. Movements of the individual shutters or group of shutters may, for example, be driven by solenoids or servo motors (not shown), which may be controlled by a computer controller and/or manually operable controls (not shown) of the aircraft unit, for example. The shutters 108 also serve as safe guards for preventing foreign objects and people from contacting the propeller 106. In addition to the shutters 108, the aircraft unit 100 may include other means for preventing foreign objects from passing through the large open gap 125 to the propeller 106, e.g., a screen made of metal or other appropriate material which completely covers the gap 125 and has openings sized to block passage of foreign objects while permitting unobstructed passage of the ambient air 120.

In addition to using the movable shutters 108, the aircraft unit 100 may also employ two or more of the directional fans 131 disposed on the upper surface of canopy 101 for purposes of controlling non-vertical movements of the aircraft while in flight. The directional fans 131 are much smaller than the fan 107 and are arranged to generate horizontal airflow for controlling movements of the aircraft unit other than vertical takeoff and lift, e.g., forward flight, backward flight, left turn, right turn, etc. By using the directional fans 131, the aircraft 100 may be fully controlled electrically without any manual controls and manually-controlled surfaces (not shown), although the aircraft unit 100 may additionally or alternatively include manual controls and manually-controlled surfaces.

With the structure of the exemplary embodiment as discussed above, the aircraft unit 100 may always operate in upright position with the high velocity air thrust 121 of the propeller 106 directly downward as FIG. 1 or FIG. 2 indicated in any take-off, flight, hover, or landing. The aircraft unit may also include some type of landing gear 165 such as plurality of legs which extend downward from the circumferential wall 107′ of the fan which would engage a support surface when the aircraft unit is not airborne. The legs may have wheels provided at their lower ends, and may be retractable to minimize drag when the aircraft unit is in flight.

As will be understood, the aircraft unit 100 as depicted in FIGS. 1-2 is a basic unit. If, for example, it is to be used as a single unit to which carries a load such as single passenger-occupant (not shown) or cargo (not shown), a support seat 160, a protective covering-enclosure for the passenger (not shown), or other support device for securing the passenger or the cargo to the aircraft, together with any instrumentation that are to be used by the passenger, controls 161, safety devices for the passenger, etc. may be supported on the upper surface of the cover 101.

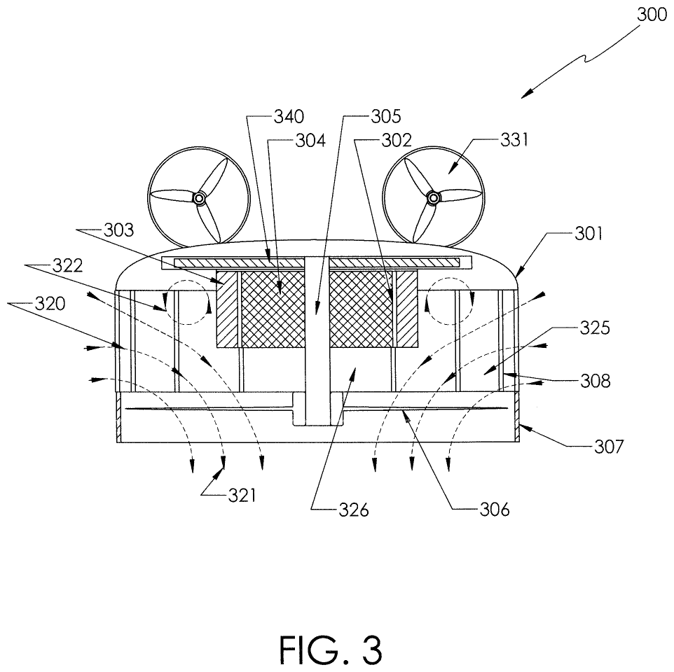

Referring to FIG. 3, there is shown a side sectional view of a compact VTOL aircraft unit 300 according to another illustrative embodiment of the present invention, which side sectional view is similar to that shown in FIG. 2. Components of the aircraft unit 300 include reference numbers that are similar to the reference numbers of the components of the aircraft 100 in FIG. 2 except the numbers begin with 3, including a canopy 301, a motor 302 having a stator 303, a rotor 304, an output shaft 305 and a flywheel 340, a duct fan 307 having a propeller 306, movable shutters 308 and directional fans 331, etc.

The main components of the aircraft unit 300 include the canopy 301 provided at an upper portion thereof, the motor 302 which is disposed below and partly covered and surrounded by the canopy, and the duct fan 307 which is disposed at a bottom portion of the aircraft unit and coaxially connected to the rotatable output shaft 305 of the motor 302 similar to the main components of the aircraft unit 100. The overall external size and shape of the aircraft unit 300 are substantially the same as those of the aircraft unit 100 as shown in FIGS. 1-2, but the aircraft unit 300 includes the motor 302 with a smaller outer circumferential diameter and a longer axial length than the motor 102 in the embodiment of FIGS. 1-2. The motor 302 is not a so-called pancake motor, but is more conventional in shape with an outer circumferential diameter which is about twice as large as its axial length as depicted. With such shape the outer circumferential periphery of the motor 300 is not fully surrounded by the canopy 301, but only the upper portion of its outer circumferential periphery is surrounded by the canopy 301, while the rest of the motor 302 extends downward in closer proximity to the duct fan 307 than is the motor 102 relative to the fan 107 in the embodiment of FIGS. 1-2. Indicated at 322 is a vortex of ambient air which cools the motor 302 similarly to the vortex 122 in the embodiment of FIGS. 1-2. Generally, because the aircraft unit 300 still requires a high power motor to generate high powered lift required for VTOL, the motor 302 has a relatively large size in both diameter and length, whereby the motor 302 extends into and occupies more of the space between the canopy 301 and the duct fan 307 than does the motor 102 in the embodiment of FIGS. 1-2. Hence, the aircraft unit 300 has less open space between the motor 302 and the fan 307 for the primary flowpath for ambient air 320 from outside of the aircraft unit, through an open gap 325 and an open space 326 to the duct fan 307, as compared to the aircraft unit 100. It would be desirable to keep the overall height of the aircraft 300 similar to that of the aircraft 100 in FIG. 2 for purposes of a compact aircraft, but to any extent that the size of the primary ambient flowpath for ambient air through the open gap 325 and the open space 326 to the fan 307 is reduced by the motor 302 the aircraft unit 300 may require an increase the vertical distance of the open gap 325, for example, to assure sufficient ambient airflow to the fan 307. Generally, the outer diameter of the motor 302 may be at least as large as the axial length of the motor. Technically, the motor 302 may be arranged in any position between the cover 301 and the fan 307.

All working principles of the aircraft unit 300 are the same as those of the aircraft unit 100 in FIGS. 1-2 except the rotor 304 of the motor 302 does not additionally function as a flywheel. Correspondingly, an optional flywheel 340 provided with the motor in this embodiment serves two functions. One function is to counter self-turning of the aircraft unit 300 when the aircraft 300 unit is airborne. The other function is simply as a flywheel to provide stability for the aircraft given the inherent instability caused by the fan 307 disposed at the bottom portion of the aircraft unit and a relatively high center of gravity as discussed above.

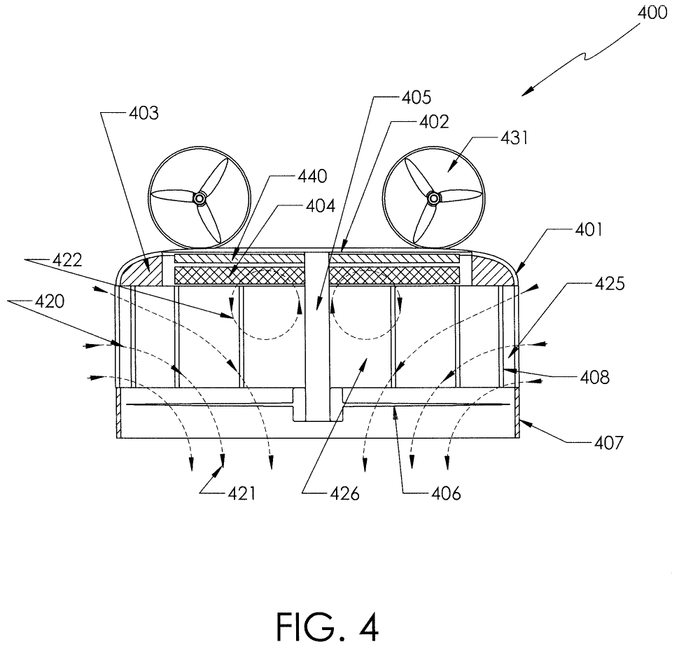

Referring to FIG. 4, there is shown a side sectional view of a compact VTOL aircraft unit 400 according to another illustrative embodiment of the present invention, which side sectional view is similar to that shown in FIG. 2. Components of the aircraft unit 400 include reference numbers that are similar to the reference numbers of the components of the aircraft unit 100 in FIG. 2 except the numbers begin with 4, including a canopy 401, a pancake motor 402 having a stator 403, a rotor 404, an output shaft 405 and a flywheel 440, a duct fan 407 having a propeller 406, movable shutters 408 and directional fans 431, etc.

The compact VTOL aircraft unit 400 is quite similar to the aircraft unit 100 except that an outer circumferential diameter of the pancake motor 402 is even larger than that of the motor 102, noting that an upper part of a casing or the housing of the motor 402 also functions as the cover 401 or the cover is a part of the motor 402 and the stator 403 extends further outward in a radial direction in very close proximity to an inner circumferential surface of the canopy 401 as compared to the stator 103 and canopy 101 of the embodiment in FIGS. 1-2. In the embodiment of FIG. 4 the outer circumferential diameter of the pancake motor 402 is essentially the same as that of the duct fan 407.

All working principles of the aircraft unit 400 are essentially the same as those of the aircraft unit 100 in FIG. 2, including that a primary flowpath for ambient air 420 from outside the aircraft unit to the duct fan 407 is through a large gap 425 and a large open space 426 between the canopy 401 and fan 407 which is not obstructed by the motor 402, the fan discharges high velocity air vertically downward 421 at high velocity, and a vortex 422 of ambient air is formed to cool the motor 402. However, because the stator 403 extends further outward in a radial direction in very close proximity to an inner circumferential surface of the canopy 401 there may not be room under the canopy 401 to store other components such as batteries and control devices as in the embodiment of FIGS. 1-2. But such other components can be mounted-supported on the upper surface of the canopy 401 or elsewhere on the vehicle.

Referring to FIG. 5, there is shown a cross-sectional view of another exemplary embodiment of a compact VTOL aircraft 500 according to the present invention. In the aircraft 500 a plurality, e.g., essentially two or more, of the aircraft units 100 in the embodiment of FIGS. 1-2 are joined together along with a cockpit 550 or enclosed passenger space disposed between the aircraft units 100 to form a larger, but still compact VTOL aircraft capable of carrying more weight than any one individual aircraft unit 100 itself can carry. Similarly, the aircraft could include multiple aircraft units 300 or 400 which are joined together with the cockpit 550, or different combinations of the aircraft units 100, 300, 400 could be joined together with the cockpit 550. In the aircraft 500 each of the aircraft units that are joined together will include most of the components as discussed above that they would include if not joined to other aircraft unit(s). For example, each of the aircraft units may include a canopy 501, a pancake motor 502, a duct fan 507 with a propeller 506, a primary airflow path defined by a large gap 525 and a large open space 526 between the canopy and duct fan, etc. Of course, each of the aircraft units which are joined together in the aircraft 500 may not have exactly the same construction as the aircraft unit 100 in FIGS. 1-2 because of considerations relating to the fact that multiple aircraft units are joined together. For example, a single set of controls and instrumentation would be sufficient for the aircraft 500, two directional fans 531 may be sufficient for maneuvering the entire aircraft 500, it may be unnecessary to provide the movable shutters 508 at portions of the aircraft units which are directly connected to the cockpit 550, etc. Also, because the cockpit 550 is disposed between the individual units, there will be more space on the upper surfaces of the canopies 501 for disposing more cargo or other components.

Operations of the aircraft 500 will be largely the same as the operations of the individual units 100, 300, 400 which are joined together in forming the aircraft 500 such as discussed above. However, if the aircraft 500 includes two of the individual aircraft units joined together, it would desirable that fans 507 of the two individual units rotate in opposite direction relative to each other so that yaw moment created in one direction by one of the units will be offset by yaw moment created in the opposite direction by other of the units as to prevent the aircraft 500 from self-spinning when airborne. In such case, there would be no particular need for the individual units to include counter flywheels 540 in the motors 502 and the counter flywheels 540 could be eliminated. The cockpit 550 should not be especially large if the aircraft 500 is to be a compact VTOL aircraft.

Also, while the cockpit 550 is depicted as being arranged between the individual aircraft units, and extending from a height above the canopies down to the bottom of the duct fans 507 in FIG. 5, it need not have such structure. For example, the cockpit 550 may be disposed at a level entirely above the canopies of the individual aircraft units, while the aircraft units may include portions which are directly connected to portions of the other individual aircraft units that are combined in the aircraft 500 without the cockpit 550 disposed between the individual aircraft units. As another example, some type of occupant supporting structure such as seat(s) or bed(s) may be disposed between or on upper surfaces of the canopies 501.

The present invention is not limited in its application to the details of construction and to the dispositions of the components set forth in the foregoing description or illustrated in the appended drawings in association with the present illustrative embodiments of the invention. The present invention is capable of other embodiments and of being practiced and carried out in various ways. In addition, it is to be understood that the phraseology and terminology employed herein are for the purposes of illustration and example, and should not be regarded as limiting. For example, while the aircraft units 100, 300, 400 are disclosed as having electric motors 102, 302, 402 and associated power sources such as batteries and/or fuel cells for driving the duct fans 107, 307, 407 other appropriate power units may be utilized for driving the duct fans 107, 307, 407 such as an internal combustion engine and fuel combusted by the engine, and multiple power units may be provided. As another example, manually operated controls may be provided for directing horizontal movements of the aircraft units when airborne, rather than or in addition to the directional fans 131, 331, 431 and the powered shutters 108, 308, 408.

As such, those skilled in the art will appreciate that the concepts, upon which this disclosure is based, may readily be utilized as a basis for the designing of other structures, methods and systems for carrying out the several purposes of the present invention. It is important, therefore, that the scope of the claims appended hereto be regarded-interpreted as including such equivalent constructions.

1. A compact Vertical Take-Off And Landing (VTOL) aircraft unit which comprises:
a duct fan including a propeller having a rotational axis which extends substantially vertically and discharges air to generate thrust sufficient for VTOL;
an electric motor disposed above the duct fan and including an output shaft operatively connected to the propeller for rotating the propeller; and
a cover disposed above the motor which is configured to support a load thereon,
wherein a gap is defined between the cover and the duct fan around an outer circumferential periphery of the aircraft and forms an opening of a primary flowpath for ambient air to the propeller, the primary flowpath for ambient air being non-parallel to the propeller's rotational axis,
wherein the electric motor further includes an internal rotor provided therewith above the duct fan, which extends parallel to the propeller and rotates around a same axis as the motor output shaft, and an outer diameter of the rotor is at least as large as an axial length of the motor so that the rotor also functions as a flywheel and produces inertial forces which stabilize the aircraft unit while airborne.

2. The compact VTOL aircraft according to claim 1, wherein the duct fan is disposed at a bottom portion of the aircraft unit, an outer circumferential diameter of the duct fan is at least as large as an outer circumferential diameter of any other component of the aircraft unit, and none of the other components of the aircraft unit substantially obstructs the air which is discharged by the duct fan.

3. The compact VTOL aircraft according to claim 1, wherein an outer diameter of the motor is at least as large as an axial length of the motor, and
wherein an open space is defined between a lower portion of the electric motor and an upper portion of the duct fan, and when air flows to the duct fan via the primary flowpath it generates a vortex of the air in the open space that cools the electric motor.

4. The compact VTOL aircraft according to claim 1, wherein an outer diameter of the motor and the outer diameter of the rotor are each multiple times as large as the axial length of the motor.

5. The compact VTOL aircraft according to claim 4, wherein an outer circumferential diameter of the cover is at least at large as an outer circumferential diameter of the motor, the cover is concave facing toward the motor, and the cover surrounds upper and side surfaces of the motor.

6. The compact VTOL aircraft according to claim 5, wherein the cover holds air and prevents the air from passing therethrough except at at least one vent opening defined in an upper surface of the cover such that the cover will function as a deployed parachute when the aircraft unit is descending.

7. The compact VTOL aircraft according to claim 5, wherein the axial length of the motor is substantially the same as a vertical height of the cover.

8. The compact VTOL aircraft according to claim 1, wherein an outer circumferential diameter of the duct fan extends further radially outward of the aircraft unit than any other component of the aircraft.

9. The compact VTOL aircraft according to claim 1, wherein an outer circumferential diameter of the cover is substantially the same as that of the duct fan.

10. The compact VTOL aircraft according to claim 1, wherein the cover is part of a casing of the motor.

11. (canceled)

12. The compact VTOL aircraft according to claim 1, further comprising two directional fans supported on the upper surface of the cover, and each said directional fan having a rotational axis extending substantially perpendicular to the rotational axis of the duct fan.

13. The compact VTOL aircraft according to claim 1, further comprising a plurality of shutters disposed in or near the gap around the outer circumferential periphery of the aircraft and which are configured to be selectively rotated individually or in groups to close any portion of the gap.

14. The compact VTOL aircraft according to claim 1, further comprising a counter flywheel disposed with the motor.

15. The compact VTOL aircraft according to claim 1, wherein a vertical height of the gap is at least ¼ as large as an outer circumferential diameter of the fan.

16. The compact VTOL aircraft according to claim 1, wherein a center of gravity of the aircraft unit is above a lift thrust generated by the duct fan.

17. A compact Vertical Take-Off And Landing (VTOL) aircraft including at least two of the VTOL aircraft units according to claim 1 joined together.

18. A compact Vertical Take-Off And Landing (VTOL) aircraft unit which comprises:
a duct fan including a propeller having a rotational axis which extends substantially vertically and discharges air to generate thrust sufficient for VTOL;
a motor disposed above the duct fan and including an output shaft operatively connected to the propeller for rotating the propeller; and
a canopy cover disposed above the motor which is configured to support a load thereon and surrounds upper and side surfaces of the motor,
wherein the canopy cover is concave facing toward the motor, and the canopy cover holds air and prevents the air from passing therethrough except at at least one vent opening defined in an upper surface of the canopy cover such that the cover functions as a deployed parachute when the aircraft unit is descending,
wherein a gap is defined between the cover and the duct fan around an outer circumferential periphery of the aircraft and forms an opening of a primary flowpath for ambient air to the propeller, the primary flowpath for ambient air being non-parallel to the propeller's rotational axis, and
wherein when the aircraft is airborne a gravity force of the aircraft unit is above a lift thrust generated by the duct fan.

19. The compact VTOL aircraft according to claim 18, wherein the motor is an electric motor, the motor includes an internal rotor which is provided therewith above the duct fan, extends parallel to the propeller and rotates around a same axis as the motor output shaft, and an outer diameter of the rotor is at least as large as an axial length of the motor so that the rotor also functions as a flywheel and produces inertial forces which stabilize the aircraft unit while airborne, and the motor is disposed beneath the cover.

20. The compact VTOL aircraft according to claim 18, wherein an outer circumferential diameter of the cover is less than or equal to an outer circumferential diameter of the fan.

21. A compact Vertical Take-Off And Landing (VTOL) aircraft unit which comprises:
a duct fan including a propeller having a rotational axis which extends substantially vertically and discharges air to generate thrust sufficient for VTOL;
an electric motor disposed above the duct fan and including an output shaft operatively connected to the propeller for rotating the propeller; and
a cover disposed above the motor which is configured to support a load thereon and surrounds upper and side surfaces of the motor,
wherein a gap is defined between the cover and the duct fan around an outer circumferential periphery of the aircraft and forms an opening of a primary flowpath for ambient air to the propeller, the primary flowpath for ambient air being non-parallel to the propeller's rotational axis,
wherein an outer diameter of the motor is at least as large as an axial length of the motor, and
wherein an open space is defined between a lower portion of the electric motor and an upper portion of the duct fan, and when air flows to the duct fan via the primary flowpath it generates a vortex of the air in the open space that cools the electric motor.
